(19) United States
(12) Patent Application Publication
(10) Pub. No.: US 2016/0275323 A1
(43) Pub. Date: Sep. 22, 2016

(54) ASSET NUMBER TAGGING DURING CONTAINER MANUFACTURE

(71) Applicant: Iron Mountain Incorporated, Boston, MA (US)

(72) Inventors: Erik Johanson, Renton, WA (US); Mark Tirre Rempe, Malvern, PA (US)

(21) Appl. No.: 15/071,542

(22) Filed: Mar. 16, 2016

Related U.S. Application Data
(60) Provisional application No. 62/133,994, filed on Mar. 16, 2015.

(51) Int. Cl. G06K 7/10; B31B 1/90; G06K 19/06; B65C 1/02; B65D 25/20

(52) U.S. Cl. CPC G06K 7/10861; B65C 1/02; B65D 25/205; G06K 19/06037; G06K 19/06028; G06K 19/06103; B31B 1/90; G09F 2003/0272

(57) ABSTRACT

A technique for identifying containers includes affixing labels indicating unique container IDs (identifiers) to containers at a point of manufacture. Labels are applied during a manufacturing process in a consistent manner. Customers are thus able to obtain pre-encoded, pre-identified containers with unique container IDs already applied.

### CROSS-REFERENCE TO RELATED APPLICATION(S):

This application claims priority to U.S. Provisional Application No. 62/133,994, filed Mar. 16, 2015, the contents and teachings of which are incorporated herein by reference in their entirety, as if set forth explicitly herein.

### BACKGROUND

Companies that specialize in long-term storage of materials may provide their customers with storage containers, such as boxes, cartons, and so forth. Customers may fill the containers with materials and affix labels to the containers. The labels may identify, for example, a container number and a customer ID. In some examples, the container number is rendered with a barcode that encodes the container number for fast and accurate reading. Customers submit their labeled boxes to facilities for long-term storage. At a point of intake, a storage facility may log the container number and customer ID of a container in a database to assist with tracking and inventory control of the customer's materials.

### SUMMARY

Unfortunately, requiring customers to affix labels to containers places a burden on customers. For example, customers may need to order labels and go to the trouble of applying the labels to containers, resulting in inconvenience. Also, the current approach of manually affixing labels is subject to human error and inconsistency.

In contrast with the prior approach, an improved technique for identifying containers includes affixing labels indicating unique container IDs (identifiers) to containers at a point of manufacture. Labels are applied during a manufacturing process in a consistent manner. Customers are thus able to obtain pre-encoded, pre-identified containers with unique container IDs already applied. Inconvenience to customers of ordering and applying labels is therefore avoided, as is the risk that human error will result in mislabeled or unlabeled containers.

Certain embodiments are directed to a method of manufacturing containers. The method includes, in an assembly line, after stamping and printing a sheet from which a container is being manufactured, affixing an adhesive-backed label to the sheet. The label includes an RFID (Radio Frequency Identification) device. The RFID device encodes a unique container ID (identifier). The container ID uniquely identifies the container from among multiple other manufactured containers.

Other embodiments are directed to a container for storing customer items. The container includes a body and a label affixed to the body during a manufacturing process of the container. The label includes an RFID (Radio Frequency Identification) device. The RFID device encodes a unique container ID, the container ID uniquely identifying the container from among multiple other containers made using the manufacturing process.

Still other embodiments are directed to a computer program product. The computer program product stores instructions which, when executed by a controller of a container manufacturing process, cause the controller to perform a method of manufacturing containers, such as the method described above.

The foregoing summary is presented for illustrative purposes to assist the reader in readily understanding example features presented herein and is not intended to be in any way limiting.

### BRIEF DESCRIPTION OF THE SEVERAL VIEWS OF THE DRAWINGS

The foregoing and other features and advantages will be apparent from the following description of particular embodiments of the invention, as illustrated in the accompanying drawings, in which like reference characters refer to the same or similar parts throughout the different views. The drawings are not necessarily to scale, emphasis instead being placed upon illustrating the principles of various embodiments of the invention. In the accompanying drawings,

FIG. 1 is a block diagram of an example arrangement for manufacturing a container labeled with a container ID;

FIG. 2 is a face-on view of an example label of FIG. 1;

FIG. 3 is an edge-on view of the example label of FIGS. 1 and 2;

FIG. 4 is a front elevation view of an example container manufactured using the arrangement of FIG. 1; and

FIG. 5 is a flowchart showing an example process for manufacturing a container with a container ID.

### DETAILED DESCRIPTION OF THE INVENTION

Embodiments of the invention will now be described. It is understood that such embodiments are provided by way of example to illustrate various features and principles of the invention, and that the invention hereof is broader than the specific example embodiments disclosed.

An improved technique for identifying containers includes affixing labels indicating unique container IDs to containers at a point of manufacture. Labels are applied during a manufacturing process in a consistent manner. Customers are thus able to obtain pre-encoded, pre-identified containers with unique container IDs already applied.

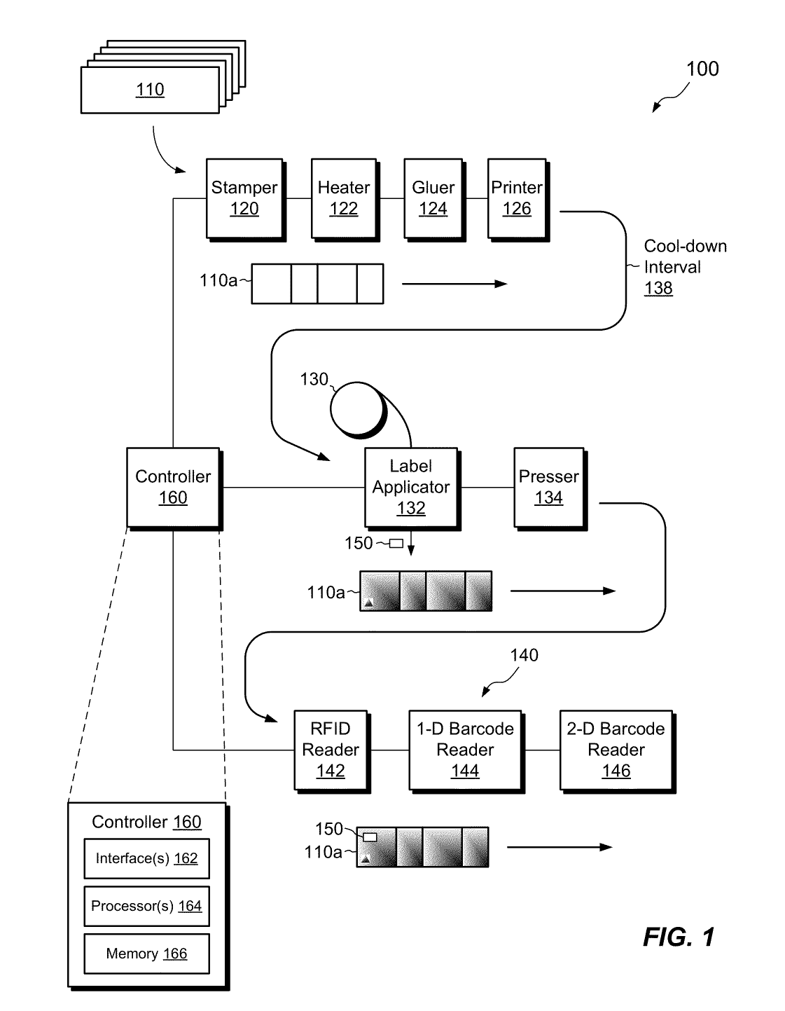

FIG. 1 shows an example assembly line 100 for manufacturing containers having pre-applied labels indicating unique container numbers. Here, sheets 110 are provided to stamper 120, heater 122, gluer 124, and printer 126, which successively process the sheets 110. For example, stamper 120 stamps a sheet 110a, e.g., to form features by removing material. Heater 122 heats the sheet 110a to a temperature that is satisfactory for gluing and printing. Gluer 124 applies glue to the sheet 110a, e.g., at designated areas or, in some cases over an entire surface of the sheet 110a. Printer 126 applies a logo and/or other markings to the sheet 110a. In some examples, printer 126 applies a thin layer of paper, which bonds with the glue, and applies markings to the paper.

The sheet 110a then travels, e.g., on a conveyer belt and/or via rollers (not shown), to label applicator 132 and presser 134. In an example, the sheet 110a experiences cool-down interval 138 as it travels, such that a temperature of the sheet 110a, or of a top surface thereof, reduces to levels that allow safe application of a label 150. Label applicator 132 is coupled to a spool 130 of labels 150. In an example, the spool 130 initially includes thousands of labels and each label 150 on the spool 130 is encoded with a unique container ID. For example, the spool 130 may initially contain labels whose container IDs extend over a consecutive range of values, with no two values being the same.

In an example, the label applicator 132 applies a single label 150 to the sheet 110a at a precisely defined location relative to the sheet 110a. The label 150 is adhesive-backed, and the label applicator 132 feeds the label 150 to the sheet 110a and applies the label 150 while the sheet 110a is in motion, such that the label 150 sticks to the sheet 110a and is carried forward. Presser 134 then applies even and consistent pressure to the label 150 to ensure fixation. For example, the presser 134 has a flat surface at least as large in planar dimensions as the label 150. As the sheet 110a passes by, the presser 134 brings down the flat surface such that it contacts the entire top surface of the label 150 and applies an even and controlled pressure to the label 150.

In an example, the pressure applied by presser 134 is large enough to ensure that the adhesive on the back of the label 150 makes uniform contact with the sheet 110a but is not so large that it damages the label 150. For example, the label 150 includes an RFID device, which may be damaged by excessive pressure and/or temperature. The pressure applied by presser 134 is preferably less than that which would damage the RFID device. For example, pressure applied by the presser 134 may be in the range between 3 and 30 kPa. In some examples, the presser 134 is implemented as part of the label applicator 132 rather than as a separate unit. Preferably, the sheet 110a is kept in a flat, unassembled condition, which is convenient for storage and shipment.

After the label 150 has been applied, the sheet 110a is conveyed to a test station 140. The test station 140 performs quality control testing on the processed sheet 110a. In an example, the label 150 includes not only an RFID device but also a one-dimensional barcode and/or a two-dimensional barcode printed on its surface. The test station 140 includes an RFID reader 142, a one-dimensional barcode reader 144, and/or a two-dimensional barcode reader 146.

The RFID reader 142 checks the RFID device in the label 150 for an expected container ID encoded in the RFID device, e.g., the next number in the sequence of labels fed from the spool 130. If the container ID read by the RFID reader 142 matches the expected value, then RFID testing passes. Otherwise, RFID testing fails. If RFID testing fails, the sheet 110a may be submitted for rework or scrapped. Alternatively, the sheet 110a may be designated for non-RFID-compatible use. Failure in RFID testing may indicate that the assembly line 100 has applied excessive temperature and/or pressure to the label 150, which has damaged the label 150 and rendered the RFID device unreadable. In the event of such a failure, the assembly line 100 may be adjusted, for example, by providing a longer cool down interval 138, by providing active cooling, and/or by reducing pressure applied by presser 134.

The one-dimensional barcode reader 144 checks a one-dimensional barcode printed on the label 150 for the expected container ID. The container ID read from the one-dimensional barcode should match an expected value, which may correspond to the value read by the RFID reader 142. If the container ID read by the reader 144 matches the expected value, then one-dimensional barcode testing passes. Otherwise, one dimensional barcode testing fails and the sheet 110a may be reworked.

The two-dimensional barcode reader 146 checks a two-dimensional barcode printed on the label 150. The container ID read from the two-dimensional barcode should match an expected value, which may correspond to the value read by the RFID reader 142 and by the one-dimensional barcode reader 144. If the container ID read by the reader 146 matches the expected value, then two-dimensional barcode testing passes. Otherwise, two dimensional barcode testing fails.

Failure in either one or two-dimensional barcode testing may indicate that temperature is too high. In an example, the label 150 includes thermal paper, which has a set of thermally printed elements that are activated at a predetermined temperature, i.e., by applying heat in a targeted way to form images. The applied heat is sufficient to raise the temperature of regions of the thermal paper to at least the predetermined temperature in the areas to be exposed. Heat in the assembly line 100, which exceeds this predetermined temperature, either during application on the label 150 or later, may expose the thermal paper in undesired ways and render one or both barcodes unreadable. If this type of failure occurs, the cool-down interval 138 may be increased and/or active cooling may be applied, to ensure that the temperature on the assembly line 100 never exceeds the predetermined temperature either during or after application of the label 150.

In some examples, only a single barcode reader 144 or 146 is provided, under the assumption that an over-temperature condition that affects one barcode will affect both, such that testing both barcodes is redundant.

In an example, a controller 160 controls operation of the assembly line 100, including operation of the stamper 120, heater 122, gluer 124, printer 126, label applicator 132, presser 134, RFID reader 142, 1-D barcode reader 144, and 2-D barcode reader 146.

In an example, the controller 160 includes one or more communication interfaces 162, a set of processors 164, and memory 166. The communication interfaces 122 include, for example, interfaces to stamper 120, heater 122, gluer 124, printer 126, label applicator 132, presser 134, RFID reader 142, 1-D barcode reader 144, and 2-D barcode reader 146, which may include direct connections, bus connections, and/or network connections, for example. The set of processors 164 includes one or more processing chips or assemblies, along with associated coprocessors and chipsets. The memory 166 includes both volatile memory (e.g., RAM), and non-volatile memory, such as one or more ROMs, disk drives, solid state drives, and the like. The set of processors 164 and the memory 166 together form control circuitry, which is constructed and arranged to carry out various methods and functions as described herein. Also, the memory 166 includes a variety of software constructs realized in the form of executable instructions. When the executable instructions are run by the set of processors 164, the set of processors 164 are caused to carry out the operations of the software constructs. Although certain software constructs are specifically shown and described, it is understood that the memory 166 typically includes many other software constructs, which are not shown, such as an operating system, various applications, processes, and daemons.

In an example, the controller 160 controls speed of the assembly line 100, duration of the cool-down interval 138, and in general controls operation of assembly line components. Some components, such as the label applicator 132, may include their own controllers, and such controllers receive commands from the controller 160, which may operate as a master. In an example, the controller 160 directs the assembly line 100 to produce containers at a rate of at least one container per minute.

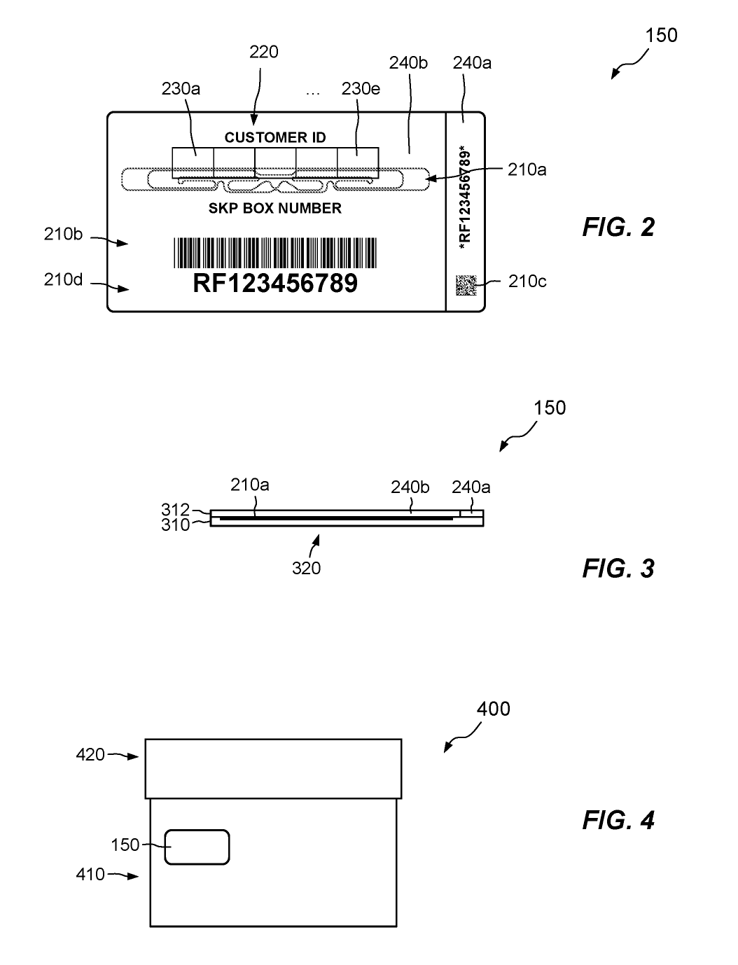

FIGS. 2 and 3 show an example label 150 in additional detail. Here, it is seen that the label 150 includes RFID device 210a, one-dimensional barcode 210b, two-dimensional barcode 210c (e.g., a QR—Quick Response—code), and a human-readable printout 210d. As shown in FIG. 3, the label 150 has a layered construction and includes a backing layer 310 and a printed layer 312. The RFID device 210a is disposed within the label 150 between the backing layer 310 and the printed layer 312.

The label 150 further includes a printed series of borders 220 that define a series of spaces, e.g., 230a to 230e. A customer receiving the container may enter a customer ID into the spaces 230a to 230e, such that the label 150 enables the customer to associate the unique container ID with the customer ID. In some examples, the customer ID may be pre-printed onto the label 150, e.g., in cases in which a customer makes a large order for containers.

The label 150 further includes a buddy tag region 240a. The buddy tag region 240a includes the two-dimensional barcode 210c and is discontinuous with other portions 240b of the printed layer 312. For example, the printed layer 312 is cut such that the buddy layer region 240 may be peeled away from the backing layer 310 without disturbing the other regions 240b. Customers may use this feature to affix a “buddy tag” to a list of container contents, which helps customers to track their items.

In an example, the backing layer 310 itself has an adhesive backing 320. The adhesive backing 320 enables the label 150 temporarily to adhere to a base strip (not shown), which is wound around the spool 130. For example, to apply the label 150 to the sheet 110a, the label applicator 132 removes the label from the base strip by peeling the label 150 off the base strip and then places the peeled label down on the sheet 110a.

In an example, the RFID device 210a, one-dimensional barcode 210b, two-dimensional barcode 210c, and human-readable printout 210d all provide the same container ID. Thus, for example, all four elements provide the identifier “RF123456789.” If manufactured without errors, the RFID reader 142 and barcode readers 144 and 146 will all read the same identifier for label 150, which corresponds to the identifier shown in the human-readable printout 210d.

FIG. 4 shows an example of a fully assembled container 400. The container 400 includes a body 410 and a lid 420. A label 150, having a different number from the one shown in FIG. 2, is affixed to the body 410. As the sheets 110 are preferably shipped to customers in a flat condition, the container 400 is shown as it would appear to a customer after opening and assembling the container 400, or as it would appear to a storage facility after receiving back the container 400 filled with contents.

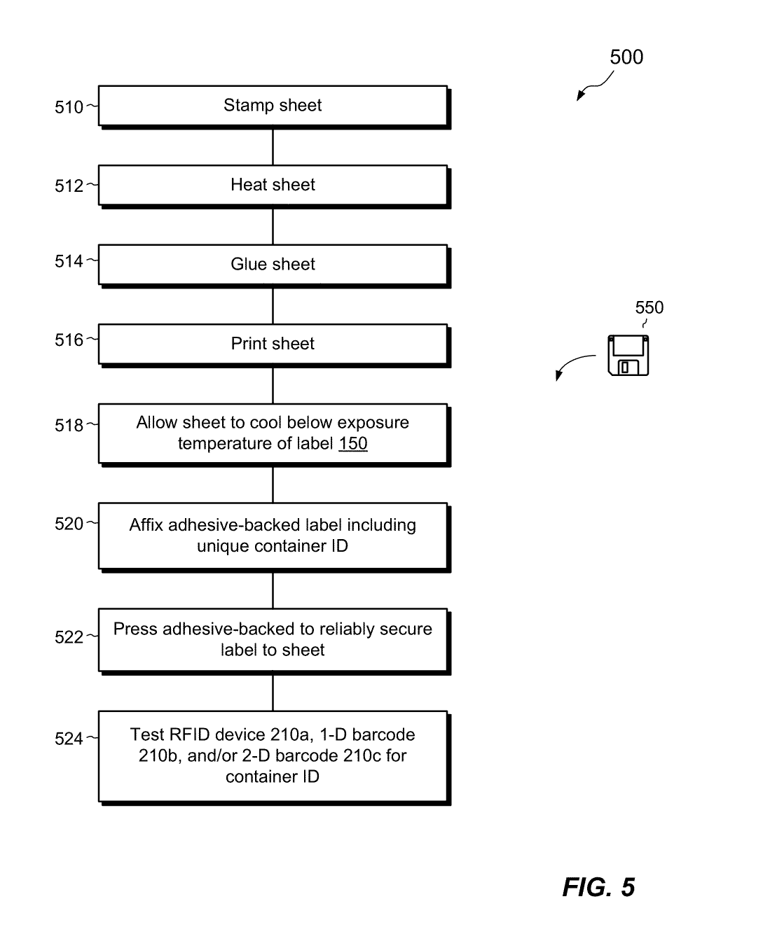

FIG. 5 shows an example process 500 that may be carried out in connection with the assembly line 100. The process 500 is typically directed by software constructs that reside in the memory 166 of the controller 160 and are run by the set of processors 164. The various acts of the process 500 may be ordered in any suitable way. Accordingly, embodiments may be constructed in which acts are performed in orders different from that illustrated, which may include performing some acts simultaneously, even though the acts are shown as sequential in the illustrated embodiments.

At 510, stamper 120 stamps a sheet 110a. At 512, heater 122 heats the sheet 110a, or one or more portions thereof, and gluer 124 applies glue at 514. At 516, printer 126 applies markings. In an example, applying markings includes placing a paper layer on the sheet 110a, e.g., over the glue 124, and then printing onto the paper.

At 518, the sheet 110a is allowed to cool for the cool-down interval 138, which enables the temperature of the sheet 110a to fall below the temperature at which thermal paper in the label 150 is exposed.

At 520, the label applicator 132 applies a label 150 form the spool 130, e.g., in a precise, reliable, and repeatable manner. At 522, presser 134 further secures fixation by pressing on the label 150 such that it adheres uniformly to the sheet 110a.

At 524, test station 140 verifies the correct container ID by reading the RFID device 210a, the one-dimensional barcode 210b, and/or the two-dimensional barcode 210c. Following successful testing, the sheet 110a is shipped to a customer, generally in a flat condition. The customer receives the sheet 110, enters its customer number in the area provided, assembles the container 400, and fills it with contents. The customer may also remove the buddy tag from portion 240a and affix it to a list of contents of the container 400. The customer may then use the RFID device 210a and/or barcodes 210b and 210c to track the container 400 and thus to track its contents.

If the container is transported offsite, e.g., for long-term storage, a storage facility may easily enter and track the container 400 using the RFID device 210a and/or barcodes 210b and 210c.

An improved technique has been described for identifying containers. The technique includes affixing labels 150 indicating unique container IDs to containers 400 at a point of manufacture. Labels 150 are applied during a manufacturing process in a consistent manner. Customers are thus able to obtain pre-encoded, pre-identified containers with unique container IDs already applied. Inconvenience to customers of ordering and applying labels is therefore avoided, as is the risk that human error will result in mislabeled or unlabeled containers.

Having described certain embodiments, numerous alternative embodiments or variations can be made. For example, although the label 150 is shown and described as including an RFID device 210a, a one-dimensional barcode 210b, and a two-dimensional barcode 210c, this is merely an example. For instance, labels 150 may be provided including more, fewer, or different indictors of container ID.

Also, although certain manufacturing steps are specifically shown and described, these are presented as illustrative examples and should not be construed as limiting.

Further, although features are shown and described with reference to particular embodiments hereof, such features may be included and hereby are included in any of the disclosed embodiments and their variants. Thus, it is understood that features disclosed in connection with any embodiment are included as variants of any other embodiment.

Further still, the improvement or portions thereof may be embodied as a computer program product including one or more non-transient, computer-readable storage media, such as a magnetic disk, magnetic tape, compact disk, DVD, optical disk, flash drive, SD (Secure Digital) chip or device, Application Specific Integrated Circuit (ASIC), Field Programmable Gate Array (FPGA), and/or the like (shown by way of example as medium 550 in FIG. 5). Any number of computer-readable media may be used. The media may be encoded with instructions which, when executed on one or more computers or other processors, perform the process or processes described herein. Such media may be considered articles of manufacture or machines, and may be transportable from one machine to another.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Further, although ordinal expressions, such as “first,” “second,” “third,” and so on, may be used as adjectives herein, such ordinal expressions are used for identification purposes and, unless specifically indicated, are not intended to imply any ordering or sequence. Thus, for example, a second event may take place before or after a first event, or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Although certain embodiments are disclosed herein, it is understood that these are provided by way of example only and that the invention is not limited to these particular embodiments.

Those skilled in the art will therefore understand that various changes in form and detail may be made to the embodiments disclosed herein without departing from the scope of the invention.

What is claimed is:

1. A method of manufacturing containers, the method comprising:
in an assembly line, after stamping and printing a sheet from which a container is being manufactured, affixing an adhesive-backed label to the sheet,
the label including an RFID (Radio Frequency Identification) device,
the RFID device encoding a unique container ID (identifier), the container ID uniquely identifying the container from among multiple other manufactured containers.

2. The method of claim 1,
wherein the label further includes a printed series of borders that defines a series of spaces into which a customer receiving the container may enter a customer ID, the label affixed to the box thereby enabling the customer to apply the customer ID to associate the unique container ID with the customer ID.

3. The method of claim 2, further comprising, prior to affixing the label, feeding the label onto the sheet from a roll of labels, the act of feeding the label performed repeatedly for multiple containers.

4. The method of claim 3, wherein feeding the label is performed repeatedly for multiple containers at a rate of at least one label per second.

5. The method of claim 2, wherein the label further includes:
a one-dimensional barcode that encodes the unique container ID;
a two-dimensional barcode that encodes the unique container ID; and
a human-readable printout of the unique container ID.

6. The method of claim 5, further comprising, after affixing the label and after performing all manufacturing steps that apply temperature and/or pressure to the sheet:
employing an RFID reader to attempt to read the RFID device; and
rejecting the container as defective in response to the RFID reader being unable to read the container ID from the RFID device.

7. The method of claim 5, further comprising heating the sheet and applying glue to the heated sheet,
wherein the label includes a set of thermally printed elements that are activated at a predetermined temperature, and
wherein affixing the label is performed only after the heated sheet has cooled to a temperature less than the predetermined temperature.

8. The method of claim 7, further comprising, after applying the label and after performing all manufacturing steps that apply temperature to the sheet:
employing a barcode reader to attempt to read the one-dimensional barcode, and
rejecting the container as defective in response to the barcode reader being unable to read the container ID from the one-dimensional barcode.

9. The method of claim 7, further comprising, after applying the label and after performing all manufacturing steps that apply temperature to the sheet:
employing a barcode reader to attempt to read the two-dimensional barcode, and
rejecting the container as defective in response to the barcode reader being unable to read the container ID from the two-dimensional barcode.

10. The method of claim 7,
wherein the label has a layered construction that includes a backing layer and a printed layer, and
wherein the two-dimensional barcode is printed on a buddy tag portion of the printed layer that is discontinuous with other portions of the printed layer to allow the buddy tag portion to be peeled away from the backing layer without removing the other portions of the printed layer.

11. The method of claim 10, wherein the RFID device is disposed within the label between the backing layer and the printed layer.

12. A container for storing customer items, the container comprising:
a body; and
a label affixed to the body during a manufacturing process of the container, the label including an RFID (Radio Frequency Identification) device, the RFID device encoding a unique container ID (identifier), the container ID uniquely identifying the container from among multiple other containers made using the manufacturing process.

13. The container of claim 12,
wherein the label further includes a printed series of borders that defines a series of spaces into which a customer receiving the container may enter a customer ID, the label affixed to the box thereby enabling the customer to apply the customer ID to associate the unique container ID with the customer ID.

14. The container of claim 13, wherein the label further includes:
a one-dimensional barcode that encodes the unique container ID;
a two-dimensional barcode that encodes the unique container ID; and
a human-readable printout of the unique container ID.

15. The container of claim 14,
wherein the label has a layered construction that includes a backing layer and a printed layer, and
wherein the two-dimensional barcode is printed on a buddy tag portion of the printed layer that is discontinuous with other portions of the printed layer to allow the buddy tag portion to be peeled away from the backing layer without removing the other portions of the printed layer.

16. The container of claim 15, wherein the RFID device is disposed within the label between the backing layer and the printed layer.

17. A computer program product including a set of non-transitory, computer-readable media having instructions which, when executed by a controller of a container manufacturing process, cause the controller to perform a method of manufacturing containers, the method comprising:
in an assembly line, after stamping and printing a sheet from which a container is being manufactured, affixing an adhesive-backed label to the sheet,
the label including an RFID (Radio Frequency Identification) device,
the RFID device encoding a unique container ID (identifier), the container ID uniquely identifying the container from among multiple other manufactured containers.

18. The computer program product of claim 17, wherein the method further comprises, prior to affixing the label, feeding the label onto the sheet from a roll of labels, the act of feeding the label performed repeatedly for multiple containers at a rate of at least one label per second.

19. The computer program product of claim 18, wherein the label further includes (i) a one-dimensional barcode that encodes the unique container ID, (ii) a two-dimensional barcode that encodes the unique container ID, and (iii) a human-readable printout of the unique container ID, and wherein the method further comprises, after affixing the label and after performing all manufacturing steps that apply temperature and/or pressure to the sheet:
employing an RFID reader to attempt to read the RFID device; and
rejecting the container as defective in response to the RFID reader being unable to read the container ID from the RFID device.

20. The computer program product of claim 19, wherein the method further comprises:
heating the sheet; and
applying glue to the heated sheet,
wherein the one-dimensional barcode is thermally printed on the label using elements that are activated at a predetermined temperature,
wherein affixing the label is performed only after the heated sheet has cooled to a temperature less than the predetermined temperature, and
wherein the method further comprises, after applying the label and after performing all manufacturing steps that apply temperature to the sheet:
employing a barcode reader to attempt to read the one-dimensional barcode, and
rejecting the container as defective in response to the barcode reader being unable to read the container ID from the one-dimensional barcode.
